(19) United States
(12) Patent Application Publication
(10) Pub. No.: US 2010/0129585 A1
(43) Pub. Date: May 27, 2010

(54) PHOTO-INITIATED, NON- AQUEOUS, TEMPERATURE INDEPENDENT GELS, AND METHOD OF PREPARATION THEREOF

(75) Inventor: Andreas Sotiriou Constantinou, Solihull (GB)

Correspondence Address: JAMES P. HANRATH, 191 NORTH WACKER DRIVE, SUITE 1800, CHICAGO, IL, 60606, US

(73) Assignee: 3LFANTS LIMITED, Byron Park, Knowle, Solihull (GB)

(21) Appl. No.: 12/598,985

(22) PCT Filed: May 8, 2008
(86) PCT No.: PCT/GB2008/001590

§ 371 Date: Nov. 5, 2009

(30) Foreign Application Priority Data
May 9, 2007 (GB) 0708921.2

(51) Int. Cl. B32B 3/02; C08F 120/02; C08J 3/28; B05D 7/22; G01D 13/00

(52) U.S. Cl. 428/64.2; 525/329.7; 522/129; 522/64; 427/230; 116/200

(57) ABSTRACT

A liquid precursor for a gel comprises liquid polyethylene glycol (PEG), a gelling component such as a mixture of acrylic derivatives and optionally a polymerization initiator. A suitable polymerization initiator is the photoinitiator diphenyl-(2,4,6-trimethylbenzoyl)phosphine oxide. Gelation may be achieved by irradiation with UV. The resulting gel may be free from water and exhibits high viscosity over a wide range of operating conditions. The gel is suitable for use in an indication device suitable for indicating exposure to an accelerating force above a desired threshold. The indication device may be used to indicate whether an information carrier (such as a computer-readable optical disc) has previously been accessed.

This invention relates to a gel precursor comprising polyethylene glycol, a gel formable from the precursor, and an article comprising the gel.

In cases where there is a risk of counterfeiting, it is known for articles to be provided with a security device which identifies the articles as originating from a particular source. For example, items such as bank notes may be provided with features such as a holographic image which is difficult for counterfeiters to reproduce, so that a person receiving the banknote can quickly check that it is genuine.

In some cases, it is useful for the consumer to be sure that an article has come directly from the manufacturer and has not previously been sold to or used by another person. For example, some computer software is sold under a license which permits installation of the software on one computer only, and is not transferable. It is therefore desirable for a purchaser to be able to ascertain that the software he is buying is correctly licensed, i.e. that it is not counterfeit and that the license has not previously been taken. It may also be desirable under consumer protection legislation to distinguish between articles which are brand new and those which are ‘second hand’, i.e. have previously been sold, especially where there are no signs of external wear and tear.

At present, products may commonly be packaged in a manner which indicates they have not previously been opened. For example, items may be shrink-wrapped, or encased in a thermally-welded plastic casing. In order to access the product, the integrity of such packaging must be destroyed, providing a visual indication to any subsequent consumer that the product has previously been opened. However, it is relatively easy for an unscrupulous vendor to repackage the product, even using a similar form of packaging, in order to market the product as being new and unused.

International (PCT) Patent Application document WO 01/71717 describes an indication device which can be applied to the product itself (in particular a disc, such as a compact disc, which in use is rotated above a certain angular velocity) and which provides a permanent indication that the product has been used. In one embodiment described therein, the disc has a sealed tube containing an indicating substance, commonly a liquid, such that the location of the liquid can be seen by the user of the disc. During manufacture, the liquid is stored within a limited part of the tube and is prevented from moving through the rest of the tube, either by the use of membranes, or simply by the viscosity or surface tension of the liquid. The absence of liquid in the remaining part of the tube then acts as the visual indication that the disc has not previously been used. When the disc is rotated in an appropriate disc drive, the inertial forces rupture the membranes or overcome the surface tension, causing the liquid to move throughout the tube.

The choice of liquid is critical to the operation of this device. In general, it is preferable to rely on the viscosity or surface tension of the liquid to retain it in the initial configuration, since this greatly simplifies manufacture. However, this places additional requirements on the properties of the liquid.

Since the device is intended to be utilized with (inter alia) consumer products, it is preferred that the liquid not be corrosive, toxic, or otherwise likely to cause harm to a person who comes into contact with it, following leakage or breakage of the product. It is desirable that introduction of the liquid into the product should be relatively simple in order to reduce the manufacturing costs and difficulty. Whilst such liquids are known in the art, there are a number of problems with existing liquids.

For example, it is desirable that the liquid should not leak from the tube during normal storage of the product, which may be for several years. In particular, water-based liquids are prone to loss via capillary action and/or evaporation.

Furthermore, many liquids experience significant changes in viscosity with temperature, such that the properties can vary significantly with changes in operating conditions, such as those between winter conditions at high latitudes and summer conditions in the tropics. It is essential to operation of a device of the type described in WO 01/71717, that the indicating liquid will not move during normal handling of the product (i.e. that the viscosity or surface tension is sufficiently high), and that the liquid will move when the disc is rotated in use (i.e. that the viscosity or surface tension are not too high), at all possible operating conditions.

It will be understood that there are may other applications where similar qualities of a gel material would be advantageous. Thus it is an object of the present invention in at least one aspect to provide a novel gel (or precursor to the gel) that has advantageous physical properties.

According to a first aspect of the invention, there is provided a liquid precursor to a gel, comprising polyethylene glycol (PEG) and a gelling component, such that on initiation of gelation, said PEG and said gelling component interact to form a gel.

In one embodiment, the gelling component is capable of polymerization. In a further embodiment, the liquid precursor additionally comprises a polymerization initiator. In a still further embodiment, the polymerization initiator comprises a photoinitiator, and initiation of gelation comprises irradiation of the liquid precursor with electromagnetic radiation. In a still further embodiment, the photoinitiator is diphenyl-(2,4,6-trimethylbenzoyl)-phosphine oxide, and initiation of gelation comprises irradiation with UV and/or blue light.

In one embodiment, the gelling component comprises at least one acrylic derivative. In a further embodiment, the gelling component comprises a mixture of more than one acrylic derivative. The gelling component may be a photoinitiated curing adhesive such as those available commercially as DELO Photobonds AD491, AD492 and PB437.

In one embodiment, the liquid precursor is free from water.

According to a second aspect of the invention, there is provided a gel obtainable by gelation of the liquid precursor of the first aspect of the invention.

In one embodiment, the gel is free from water.

According to a third aspect of the present invention, there is provided a method of forming a gel, comprising mixing a liquid polyethylene glycol (PEG) with a gelling component, and treating the mixture to initiate gelation of the mixture.

In one embodiment, the gelling component is a polymerizable material, and treating the mixture to initiate gelation comprises initiating polymerization of the gelling component.

In one embodiment, the liquid polyethylene glycol is a viscous liquid.

In one embodiment, both the polyethylene glycol and the gelling component are liquid.

In one embodiment, the gelling component comprises at least one acrylic derivative. In a further embodiment, the gelling component comprises more than one acrylic derivative.

In one embodiment, the method comprises initiating polymerization with a polymerization initiator. The polymerization initiator may be added separately to the liquid polyethylene glycol and the gelling component, or may be premixed with the polyethylene glycol or (preferably) the gelling component. In a still further embodiment, the polymerization initiator comprises a photoinitiator. In a still further embodiment, the photoinitiator is diphenyl-(2,4,6-trimethylbenzoyl)phosphine oxide.

In one embodiment, treating the mixture to initiate gelation of the mixture comprises irradiating the mixture with electromagnetic radiation. In a further embodiment, the electromagnetic radiation comprises UV radiation.

According to a fourth aspect of the present invention, there is provided an indication device comprising
a tube having
   a first part containing a gel in accordance with the second aspect of the invention, and
   a second part which is substantially free from the gel,
      wherein subjecting the indication device to a force greater than a threshold value causes at least a portion of the gel to travel to the second part of the tube, whereas there is no such travel of the gel at forces below the threshold value.

It will be understood that the gel is self-supporting and hence that there is no requirement for any means to retain the gel in the first part of the tube.

In one embodiment, the gel may be coloured.

The indication device may be formed integrally with the device on which it is to be used, or it may be formed separately and then attached later.

According to a fifth aspect of the present invention, there is provided an information carrier comprising the indication device of the fourth aspect of the invention.

In one embodiment, the information carrier is rotatable by drive means to retrieve information stored thereon. In a further embodiment, the information carrier is suitable for use in an optical disc drive. In a still further embodiment, the information carrier is a disc such as a compact disc or DVD.

As used herein, the phrase ‘rotatable by drive means to retrieve information stored thereon’ means that the information carrier (or a part of the information carrier) is adapted to be rotated in use to access the information stored on the carrier; typically information is read from a carrier by a reading head having limited mobility, and rotation of the carrier allows the reading head access to the entire surface of the carrier. Such a system is typically found in (but is not limited to) computer disc drives and other systems designed to read magnetic or optical discs. As used herein, the term ‘disc’ refers to a planar information carrier, as is well understood in the art, and may include magnetic discs such as floppy disks and hard disks, optical discs such as laser discs, compact discs and DVDs, magneto-optical discs, and the suchlike. Whilst such ‘discs’ are typically circular, this is not necessarily the case; it is known for ‘discs’ readable in computer CD-ROM or DVD-ROM drives to be rectangular or any other (preferably symmetrical) shape.

According to a sixth aspect of the present invention, there is provided a method of manufacturing an information carrier having a motion-detecting device, comprising:
a) providing an information carrier comprising a tube, wherein the tube has at least one opening in the surface of the information carrier;
b) inserting into the tube, via the opening, a gel precursor in accordance with the first aspect of the invention, so as to occupy a portion but less than substantially all of the tube; and
c) treating the gel precursor to cause gel formation.

For practical reasons, the components of the gel precursor will normally be premixed before insertion into the tube. However, it may be possible for the components of the gel precursor to be added separately to the tube, with mixing taking place within the tube. The invention should be construed so that such a possibility is within its scope.

The invention will now be described by way of example.

Four parts polyethylene glycol (average molecular weight ca. 400) and 1 part DELO-PHOTOBOND AD491 (an adhesive manufactured by DELO Industrieklebstoffe GmbH & Co. KG, Ohmstraβe 30, 86899 Landsberg, Germany) were blended gently by barrel rolling whilst preventing exposure to UV, to obtain an oily liquid precursor of loose consistency. Exposure of this precursor to UV resulted in conversion of the oily precursor to a firm gel.

The DELO-PHOTOBOND AD491 has the following composition (manufacturer's data sheet):
25-75% isobornyl acrylate
25-75% acrylate resin (“Acrylharz”)
10-50% acrylic acid
2.5-30% acryloylmorpholin
0-10% diphenyl(2,4,6-trimethylbenzoyl)phosphine oxide.

1. A liquid precursor to a gel, comprising polyethylene glycol (PEG) and a gelling component, such that on initiation of gelation, said PEG and said gelling component interact to form a gel.

2. The liquid precursor of claim 1, wherein the gelling component is capable of polymerization.

3. The liquid precursor of claim 2, further comprising a polymerization initiator.

4. The liquid precursor of claim 3, wherein the polymerization initiator comprises a photoinitiator, and initiation of ° elation comprises irradiation of the liquid precursor with electromagnetic radiation,

5. The liquid precursor of claim 4, wherein the photoinitiator is diphenyl-(2,4,6-trimethylbenzoyl)phosphine oxide, and initiation of gelation comprises irradiation with UV and/or blue light.

6. The liquid precursor of claim 1, wherein the gelling component comprises at least one acrylic derivative.

7. The liquid precursor of claim 6, wherein the gelling component comprises a mixture of more than one acrylic derivative.

8. The liquid precursor of claim 1, wherein the liquid precursor is free from water.

9. A gel obtainable by gelation of the liquid precursor of claim 1.

10. A method of forming a gel, comprising mixing a liquid polyethylene glycol (PEG) with a gelling component, and treating the mixture to initiate gelation of the mixture.

11. An indication device comprising a tube having a first part containing the gel of claim 9, and a second part which is substantially free from the gel; wherein subjecting the indication device to a force greater than a threshold value causes at least a portion of the gel to travel to the second part of the tube, whereas there is no such travel of the gel at forces below the threshold value.

12. The indication device of claim 11, wherein the gel is coloured.

13. An information carrier comprising the indication device of claim 11.

14. The information carrier of claim 13 wherein the information carrier is suitable for use in an optical disc drive.

15. A method of manufacturing an :information carrier having a motion-detecting device, comprising
a) providing an information carrier comprising a tube, wherein the tube has at least one opening in the surface of the information carrier;
b) inserting into the tube, via the opening, the gel precursor of claim 1, so as to occupy a portion but less than substantially all of the tube; and
c) treating the gel precursor to cause gel formation.

16. An information carrier comprising the indication device of claim 12.

17. The information carrier of claim 16, wherein the information carrier is suitable for use in an optical disc drive.
